(19) United States
(12) Patent Application Publication
(10) Pub. No.: US 2025/0136028 A1
(43) Pub. Date: May 1, 2025

(54) METHOD AND APPARATUS FOR SETTING DRIVING MODE OF VEHICLE

(71) Applicant: HL MANDO CORPORATION, Gyeonggi-do (KR)

(72) Inventors: Jaegyu LEE, Gyeonggi-do (KR); Doheon LEE, Gyeonggi-do (KR); Yonghyun CHO, Gyeonggi-do (KR); Manki KIM, Gyeonggi-do (KR)

(21) Appl. No.: 18/785,508

(22) Filed: Jul. 26, 2024

(30) Foreign Application Priority Data
Oct. 27, 2023 (KR) 10-2023-0145481

(51) Int. Cl. B60R 16/037; B60W 50/08; G06F 21/31

(52) U.S. Cl. CPC B60R 16/037; B60W 50/082; B60W 50/085; G06F 21/31

(57) ABSTRACT

In a method and apparatus for setting a driving mode of a vehicle, an electronic device may perform login based on a user information received from a user device; setting a tuning map based on a signal received from the user device; and remotely setting the driving mode of the vehicle based on the tuning map.

### CROSS-REFERENCE TO RELATED APPLICATION

This application claims priority to and the benefit of Korean Patent Application No. 10-2023-0145481, filed on Oct. 27, 2023, the disclosures of which is incorporated herein by reference in its entirety.

### FIELD

The present disclosure generally relates to a method and apparatus for setting a driving mode of a vehicle.

### BACKGROUND

Vehicle's driving devices include braking, steering, and suspension, etc., and are generally operated as an embedded system in which hardware is manipulated according to the operation of software. For some components of the driving device, there are two or four modes of driving selection modes that can be supported, such as sports mode, eco-mode, and comfort mode. However, for most components, tuning values are fixed for convenience of development process and safety in use process, so it is difficult to reflect the request for each user.

In view of strengthening the personalization of the vehicle according to the driver and improving the convenience of the driver, the demand for tuning the driving/operation mode to suit to the driver's preference is increasing. Tunable items include brake sensitivity in the case of braking, the degree of heaviness of the steering wheel in the case of steering, and the degree of rigidity felt by the user in the case of suspension.

However, even if the driving/operation mode is tuned according to the driver's preference, the driver may have no choice but to select among driving selection modes supported by the vehicle's driving devices. Accordingly, there is a need to develop technology to perform various tuning of the driving device by reflecting the driver's preference within a safe range.

### SUMMARY

Some embodiments of the present disclosure to solve these conventional problems provide a method and apparatus for setting a driving mode of a vehicle in which individual tuning for each component of a driving device can be performed remotely according to a driver's driving tendency and road conditions, etc.

In addition, certain embodiments of the present disclosure provide a method and apparatus for setting a driving mode of a vehicle in which a driver can perform individual tuning for each component of a driving device at a new perspective by sharing a tuning map set by each of a plurality of drivers.

In addition, some embodiments of the present disclosure may provide a method and apparatus for setting a driving mode of a vehicle in which a driver can perform individual tuning for each component of a driving device within a safe range through communication with a professional engineer when performing individual tuning for each component of the driving device.

The method for setting a driving mode of a vehicle according to an embodiment of the present disclosure may include performing, with an electronic device, login based on a user information received from a user device; setting, with the electronic device, a tuning map based on a signal received from the user device; and remotely setting, with the electronic device, the driving mode of the vehicle based on the tuning map.

In addition, the setting a tuning map may include receiving a selection signal for a tuning component and a tuning range for generating the tuning map from the user device; and setting the tuning map based on the selection signal.

In addition, the method may further include setting, with the electronic device, the tuning map based on the tuning range received from at least one expert device when the tuning range received from the user device exceeds a threshold range.

In addition, the method may further include paying, with the electronic device, a fee to the at least one expert device to set the tuning map based on the tuning range received from the expert device.

In addition, the method may further include receiving, with the electronic device, at least one tag related to the set tuning map from the user device and adding the tag to the tuning map.

In addition, the setting a tuning map may include identifying a recommendation condition of the tuning map received from the user device; and identifying the tuning map corresponding to the recommendation condition in at least one tuning map received and stored from a plurality of other user devices and at least one tuning map learned and stored through an artificial intelligence algorithm.

In addition, the identifying a recommendation condition of the tuning map may include identifying at least one tag stored in the user device as the recommendation condition of the tuning map.

In addition, the identifying a recommendation condition of the tuning map may include identifying a driving data of the vehicle corresponding to the user device as the recommended condition of the tuning map.

In addition, the identifying a recommendation condition of the tuning map may include identifying at least one tag stored in the user device and a driving data of the vehicle as the recommended condition of the tuning map.

In addition, the stored at least one tuning map may include at least one tuning map received from the plurality of other user devices, a feedback information on the tuning map, a tag information set in the tuning map, and a driving data information on the tuning map,

In addition, the apparatus for setting a driving mode of a vehicle according to the embodiment of the present disclosure may include a communicator that performs communication with a user device and a vehicle device that sets the driving mode of the vehicle; and a controller that performs login based on a user information received from the user device, generates a control signal for setting the driving mode of the vehicle according to a tuning map set based on a signal received from the user device, and controls the communicator to transmit the control signal to the vehicle device.

In addition, the controller may set the tuning map based on a selection signal for a tuning component and a tuning range for generating the tuning map, wherein the selection signal is received from the user device.

In addition, the controller may set the tuning map based on the tuning range received from at least one expert device when the tuning range received from the user device exceeds a threshold range.

In addition, the controller may pay a fee to the at least one expert device to set the tuning map based on the tuning range received from the expert device.

In addition, the controller may receive at least one tag related to the set tuning map from the user device and adding the tag to the tuning map.

In addition, the controller may identify a recommendation condition of the tuning map received from the user device, and identify the tuning map corresponding to the recommendation condition in at least one tuning map received and stored from a plurality of other user devices and at least one tuning map learned and stored through an artificial intelligence algorithm.

In addition, the controller may identify at least one tag stored in the user device as the recommendation condition of the tuning map.

In addition, the controller may identify a driving data of the vehicle corresponding to the user device as the recommended condition of the tuning map.

In addition, the controller may identify at least one tag stored in the user device and a driving data of the vehicle as the recommended condition of the tuning map.

In addition, the controller may include at least one tuning map received from the plurality of other user devices, a feedback information on the tuning map, a tag information set in the tuning map, and a driving data information on the tuning map.

A method and apparatus for setting a driving mode of a vehicle according to some embodiments of the present disclosure may have the effect of performing individual tuning for each component of a driving device according to a driver's driving tendency and road conditions remotely, thereby easily performing tuning of the driving device.

In addition, a method and apparatus for setting the driving mode of the vehicle according to certain embodiments of the present disclosure may share a tuning map set by each of a plurality of drivers, thereby allowing a driver to perform individual tuning for each component of the driving device from a new perspective, and reducing the concerns about tuning values.

Additionally, a method and apparatus for setting a driving mode of a vehicle according to some embodiments of the present disclosure may have the effect of allowing a driver to perform individual tuning for each component of a driving device within a safe range through communication with a professional engineer when performing individual tuning for each component of the driving device, thereby reducing the mistake associated with setting tuning values.

### BRIEF DESCRIPTION OF THE DRAWINGS

FIG. 1 is a block diagram showing a main configuration of a system for setting a driving mode of a vehicle according to an embodiment of the present disclosure.

FIG. 2 is a block diagram showing a main configuration of an electronic device for setting a driving mode of a vehicle according to an embodiment of the present disclosure.

FIG. 3 is a flowchart for illustrating a method for setting a driving mode of a vehicle according to an embodiment of the present disclosure.

FIG. 4 is a flowchart for illustrating a method for recommending a tuning map according to an embodiment of the present disclosure.

FIG. 5 is a flowchart for illustrating a method for generating a tuning map according to an embodiment of the present disclosure.

### DETAILED DESCRIPTION

Hereinafter, preferred embodiments according to the present disclosure will be described in detail with reference to the accompanying drawings. The detailed description that will be disclosed below together with the accompanying drawings is intended to explain exemplary embodiments of the present disclosure, and is not intended to represent the only embodiments in which the present disclosure can be practiced. In the drawings, parts irrelevant to the description may be omitted to clearly explain the present disclosure, and the same reference numerals may be used for the same or similar components throughout the specification.

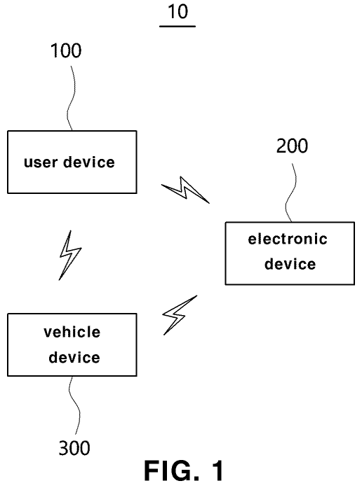

FIG. 1 is a block diagram showing a main configuration of a system for setting a driving mode of a vehicle according to an embodiment of the present disclosure.

Referring to FIG. 1, a system 10 according to an embodiment of the present disclosure may include a user device 100, an electronic device 200, and a vehicle device 300.

The user device 100 may be a device used by or associated with a driver who drive the vehicle, and may be, for example, but not limited to, a portable device such as a smart phone, a tablet PC, or an electronic device such as a computer. The user device 100 may run an application configured to select a tuning map for setting a driving mode of the vehicle and be connected to the electronic device 200 through login. The tuning map may be a map for tuning a damping force range of the vehicle's suspension, heavy to light range of the vehicle's steering, an effort range of the vehicle's brake pedal.

After the user device 100 is connected to the electronic device 200 through the application, the user device 100 may transmit a tag for a driving tendency of a driver or user to the electronic device 200, and may transmit driving data received from the vehicle device 300 to the electronic device 200.

In addition, the user device 100 may receive a tuning value for the driving device from the driver or user and transmit the tuning value to the electronic device 200 to generate the tuning map. The user device 100 may identify various tuning maps uploaded and stored in the electronic device 200 from other user devices, and may transmit various feedback to the tuning maps. The user device 100 may select one of the various tuning maps and set the selected tuning map to be applied to the driver's or user's vehicle. For example, the user device 100 may set different tuning maps based on commuting time, weight of the vehicle (e.g., occupant, luggage, etc.), road conditions, and road surface conditions.

The electronic device 200 may be a device configured to provide an application to a plurality of user devices, and may be, for example, but not limited to, an electronic device such as a cloud server. The application provided by the electronic device 200 may remotely tune the driving device of the user's vehicle pre-registered in the application by the user who has performed login. The application may be configured to perform a community function in which the user device 100 may identify the tuning map shared by other user devices and leave feedback.

In addition, the application may be configured to recommend a tuning map to the user device 100 based on one or more of a tag selected by the user device 100 or a driving data received from the user device 100. The application may be configured to generate a tuning map based on the tuning value received from the user device 100, and may select a tuning map shared by the other user devices. The application may perform various functions such as identifying the driving data of the vehicle when the vehicle registered in the user device 100 is driven, recommending an appropriate tuning map for the user's vehicle registered in the user device 100 based on the driving data, and remotely tuning the driving device of the vehicle. As described above, operations such as generating a tuning map, recommending the tuning map, and setting the tuning map are performed through the application, but for convenience of explanation, the electronic device 200, not the application, performs corresponding operations as an example in the present disclosure.

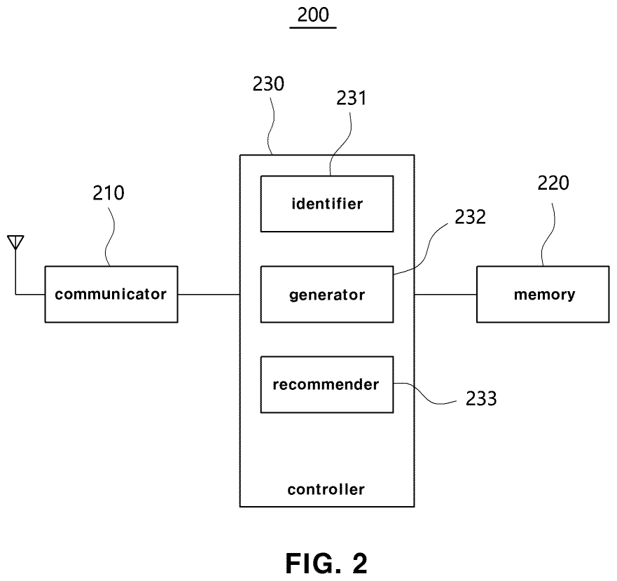

The electronic device 200 may select a tuning map to be applied to the vehicle corresponding to or associated with the user device 100 through communication with the user device 100 using the application, and provide the selected tuning map to the vehicle device 300 to remotely perform tuning such as a brake, steering, and suspension, which are driving devices of the vehicle. Exemplary embodiments of More specific operations of the electronic device 200 will be described with reference to FIG. 2 below.

The vehicle device 300 may be provided in a vehicle to communicate with the electronic device 200, and may control settings for the driving device of the vehicle based on the tuning map received from the electronic device 200. In addition, the vehicle device 300 may include a plurality of sensors to obtain driving data of the vehicle being driven and transmit it to the user device 100.

The vehicle device 300 may perform tuning of the vehicle's driving devices such as a brake, steering, and suspension by remote control of the electronic device 200.

FIG. 2 is a block diagram showing a main configuration of an electronic device for setting a driving mode of a vehicle according to an embodiment of the present disclosure. The electronic device 200 according to an embodiment of the present disclosure may be a device configured to communicating with the user device 100 and the vehicle device 300. For example, the electronic device 200 may be a cloud server, but the term “electronic device” will be collectively referred to in the present disclosure for convenience of explanation.

Referring to FIG. 2, the electronic device 200 according to an embodiment of the present disclosure may include a communicator 210, a memory 220, and a controller 230.

The communicator 210 may be configured to perform communication with the user device 100 and the vehicle device 300. To this end, the communicator 210 may perform communication such as 5G (5th generation communication), LTE-A (long term evolution-advanced), LTE, and Wi-Fi (wireless fidelity),

The memory 220 may be configured to store an operation program for operating the electronic device 200. In particular, the memory 220 may store a tuning map generated from the user device 100 and other user devices. In this example, the memory 220 may receive a tag representing driver tendency from the user device 100 and map the received tag to the tuning map generated by the user device 100 and store them together. In addition, the memory 220 may store a basic tuning map provided by a vehicle manufacturer, such as a sport mode, eco-mode, and comfort mode.

The memory 220 may store an artificial intelligence algorithm for generating the tuning map based on the driving data and the driver tendency received from the user device 100, and may store the tuning map generated therethrough. The memory 220 may store an algorithm for recommending the tuning map suitable for the user device 100 by a request from the user device 100.

The controller 230 performs login based on user information received from the user device 100, generates a control signal for setting the driving mode of the vehicle according to the tuning map set based on the signal received from the user device 100, and transmits the control signal to the vehicle device 300. To this end, the controller 230 may include an identifier 231, a generator 232 and a recommender 233. For example, the controller 230 may comprise one or more processors and memory.

The identifier 231 receives an ID and password for login from the user device 100 and performs login of the user device 100. The identifier 231 may identify a signal received from the user device 100 and provide the signal to either one or both of the generator 232 and the recommender 233.

The generator 232 may generate a tuning map by the tuning value received from the user device 100. More specifically, the generator 232 identifies a tuning range of a tuning component according to a selection signal for the tuning component received from the user device 100 and displays the tuning component on the user device 100. The tuning component may be one or more devices of the vehicle such as the brake, the steering, the suspension, and any device included in the vehicle. The tuning range may be the damping force range of the vehicle's suspension, heavy to light range of the vehicle's steering, the effort range of the vehicle's brake pedal. When the range of the expert area is selected from a tunable range from the user device 100, the generator 232 requests the user device 100 to pay a fee to set the tuning value included in the expert area. When the fee is paid from the user device 100, the generator 232 recommends an expert device related to the tuning components selected from among pre-registered expert devices to the user device 100. Through this, the user device 100 may generate the tuning map by setting the tuning component and the tuning value in the expert area through the communication with the expert related to the expert device.

When no range of the expert area is selected from the tunable range by the user device 100, the generator 232 identifies the tuning value for the tuning components selected from the user device 100. The generator 232 generates the tuning map based on the tuning component and the tuning value selected in the user device 100.

When the tag for the tuning map generated from the user device 100 is received, the generator 232 may add the received tag to the tuning map. When a tuning map generation completion signal is received from the user device 100, the generator 232 may store the tuning map to which the tag is added in the memory 220.

The recommender 233 may recommend an appropriate tuning map to the user device 100 according to an input of the user device 100. More specifically, when the tag is selected from the user device 100 under the recommendation condition, the recommender 233 identifies the tag stored in the user device 100. In this case, the tag stored in the user device 100 may be a tag selected by the user device 100 from among the hash tags provided by the electronic device 200 or directly input when the user subscribes to the application. For example, the tag may include tags such as comfortable driving, novice driving, high-speed driving, safe driving, active driving, city driving, off-road driving, highway, rain road, snowy road, rapid curve, family travel, pets, commuting, traffic jam, speed bump, overtime driving, night driving, fuel-efficient driving, child protection zone, senior protection zone, ramp, surrogate driving, tailgating, high beam, quick cut-in, and turn signal failure. The recommender 233 may estimate the driver's driving tendency based on the tag selected by the user device 100.

The recommender 233 may identify a tuning map with the same or similar tag as the tag stored in the user device 100 as a recommended tuning map among the plurality of tuning maps stored in the memory 220 and transmit the list of the identified recommended tuning maps to the user device 100.

In addition, when the driving data is selected by the user device 100 under the recommendation condition, the recommender 233 identifies the driving data of the vehicle stored in the user device 100. To this end, the user device 100 may identify the driving data while the vehicle is traveling through real-time or periodic communication with the vehicle device 300. The driving data may include information such as a position of the vehicle being driven, a road state (e.g. straight road, curved road) on which the vehicle is driving, a road surface state (e.g. gravel road, cement road, dirt road), a driving speed at the position of the vehicle, and a steering angle. The recommender 233 may analyze the driving data of the vehicle to identify the driver's driving tendency. More specifically, the recommender 233 may estimate the driver's driving tendency by classifying it into indices such as city driving, high-speed driving, fuel-efficient driving, comfortable driving, off-road driving, and sporty driving through driving data analysis.

The recommender 233 identifies a tuning map related to the driver's driving tendency estimated based on the identified driving data of the vehicle as a recommended tuning map among the plurality of tuning maps stored in the memory 220. The recommender 233 may transmit a list of the identified recommendation tuning maps to the user device 100.

In addition, when a tag and driving data are selected as recommendation conditions from the user device 100, the recommender 233 identifies the tag stored in the user device 100 and the driving data of the vehicle. The controller 230 may cross-analyze the tag and the driving data of the vehicle to estimate the driving tendency of the driver.

The recommender 233 identifies a recommendation tuning map related to the driver's driving tendency estimated based on the identified tag and driving data as a recommended tuning map among the plurality of tuning maps stored in the memory 220. The recommender 233 may transmit a list of the identified recommendation tuning maps to the user device 100.

When an application signal for applying the tuning map to the vehicle is received from the user device 100, the identifier 231 may identify whether application conditions such as time or an environment for applying the tuning map to the vehicle are set. At this time, the application conditions may be the commuting time of the vehicle, the weight of the vehicle (e.g. occupant, luggage, etc.), weather conditions, road conditions, road surface conditions, and the like.

The identifier 231 may generate a control signal and transmit it to the vehicle device 300 so that the tuning map corresponding to the application signal may be applied to the driving device of the vehicle. Through this, when the vehicle's ignition is turned on, the vehicle device 300 may tune the vehicle's driving device according to the tuning map by the control signal received from the identifier 231.

In addition, when the application conditions are set, the vehicle device 300 may tune the driving device of the vehicle according to the tuning map when the current time at the time of the start of the vehicle, the weight of the vehicle, the weather conditions, and the like converge to the application conditions. In addition, when the application conditions are set, the vehicle device 300 may tune the driving device of the vehicle according to the tuning map when the current time when the vehicle is driving, the weight of the vehicle, the weather conditions, the road conditions, the road surface conditions, and the like converge to the application conditions.

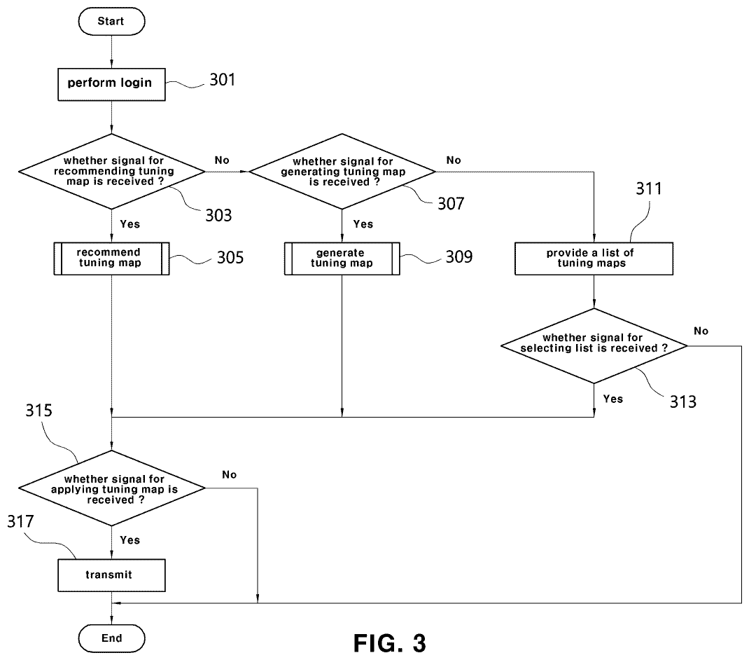

FIG. 3 is a flowchart for illustrating a method for setting a driving mode of a vehicle according to an embodiment of the present disclosure.

Referring to FIG. 3, in Step 301, the controller 230 receives an ID and password for logging-in through an application installed on the user device 100 and performs the login in the user device 100. When the login of the user device 100 is completed, the controller 230 may recommend an appropriate tuning map to the user device 100 based on input received from the user device 100. The controller 230 may generate the tuning map based on tuning values received from the user device 100 and provide a list of the plurality of tuning maps stored in the memory 220 to the user device 100.

To this end, in Step 303, the controller 230 determines whether a signal for recommending the tuning mail is received from the user 100 or not. The controller 230 performs Step 305 when a signal for recommending the tuning map is received from the user device 100, and performs step 307 when no signal for recommending the tuning map is received. In Step 307, the controller 230 determines whether a signal for generating the tuning map is received from the user device 100 or not. The controller 230 performs Step 309 when a signal for generating the tuning map is received from the user device 100, and performs Step 311 when no signal for generating the tuning map is received. In Step 311, the controller 230 provides a list of various tuning maps uploaded from other user devices and stored in the memory 220 to the user device 100.

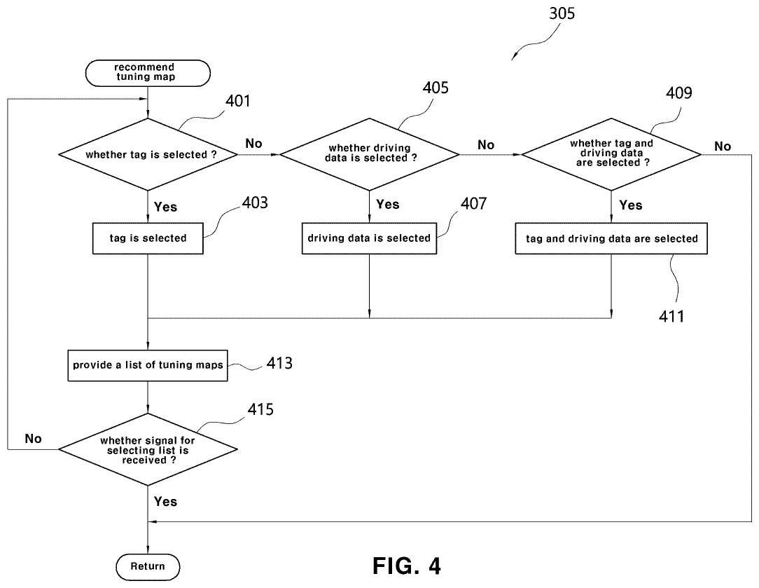

In Step 305, the controller 230 recommends the tuning map according to the signal received from the user device 100 and performs Step 315. An operation of recommending the tuning map will be described in more detail with reference to FIG. 4 below.

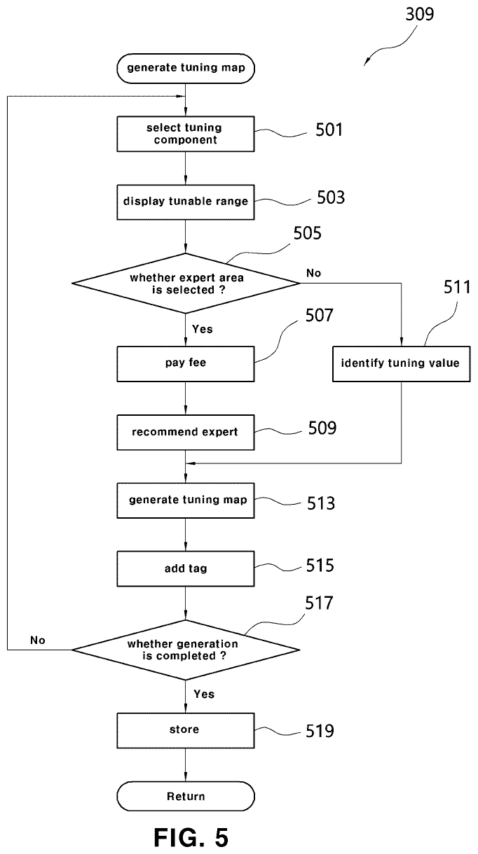

In addition, in Step 309, the controller 230 generates the tuning map according to the signal received from the user device 100 and performs Step 315. An operation of generating the tuning map will be described in more detail with reference to FIG. 5 below.

In addition, when a signal for selecting at least one tuning map from the tuning map list provided to the user device 100 is received in Step 313, the controller 230 may perform Step 315 and when no signal for selecting is received, the controller 230 terminate the corresponding process.

Subsequently, in Step 315, the controller 230 may perform Step 317 when an application signal for applying any one of the tuning map recommended in Step 305, the tuning map generated in Step 309, and the tuning map selected in Step 313 is received, and terminate the corresponding process when no application signal is received. In Step 315, when the application signal is received, the controller 230 may identify whether application conditions such as time or environment for applying the tuning map to the vehicle are set. At this time, the application conditions may be the commuting time of the vehicle, the weight of the vehicle (e.g. occupant, luggage, etc.), weather conditions, road conditions, road surface conditions, and the like.

In Step 317, the controller 230 may generate a control signal and transmit it to the vehicle device 300 so that the tuning map corresponding to the application signal may be applied to the driving device of the vehicle. Through this, when the vehicle's ignition is turned on, the vehicle device 300 may tune the vehicle's driving device according to the tuning map by the control signal received from the controller 230.

In addition, when the application conditions are set, the vehicle device 300 may tune the driving device of the vehicle according to the tuning map when the current time at the time of the start of the vehicle, the weight of the vehicle, the weather conditions, and the like converge to the application conditions. In addition, when the application conditions are set, the vehicle device 300 may tune the driving device of the vehicle according to the tuning map when the current time when the vehicle is driving, the weight of the vehicle, the weather conditions, the road conditions, the road surface conditions, and the like converge to the application conditions.

FIG. 4 is a flowchart illustrating a method of recommending a tuning map according to an embodiment of the present disclosure.

Referring to FIG. 4, in Step 401, the controller 230 determines whether a tag is selected as a recommendation condition for recommending the tuning map from the user device 100. The controller 230 performs Step 403 when a tag is selected as a recommendation condition for recommending the tuning map from the user device 100, and when the tag is not selected, the controller 230 performs Step 405.

In Step 403, the controller 230 identifies the tag stored in the user device 100 and performs Step 413. At this time, the tag stored in the user device 100 may be a tag that the user enters directly when logging in to the application for the first time, or may be a tag selected by the user device 100 among hashtags provided by the electronic device 200. For example, the tag may include tags such as comfortable driving, novice driving, high-speed driving, safe driving, active driving, city driving, off-road driving, highway, rain road, snowy road, rapid curve, family travel, pets, commuting, traffic jam, speed bump, overtime driving, night driving, fuel-efficient driving, child protection zone, senior protection zone, ramp, surrogate driving, tailgating, high beam, quick cut-in, and turn signal failure. The controller 230 may estimate the driver's driving tendency based on the tag selected by the user device 100.

In Step 413, the controller 230 identifies a tuning map with the same or similar tag as the tag identified in step 403 as a recommended tuning map among the plurality of tuning maps stored in the memory 220. The controller 230 may transmit a list of identified recommended tuning maps to the user device 100. In Step 415, when a signal for selecting any one of the lists is received from the user device 100, the controller 230 returns to Step 315 of FIG. 3.

In Step 405, when driving data is selected as a recommendation condition for recommending a tuning map from the user device 100, the controller 230 performs Step 407, and when the driving data is not selected, the controller 230 performs Step 409.

In Step 407, the controller 230 identifies the driving data of the vehicle stored in the user device 100. To this end, the user device 100 may identify the driving data while the vehicle is driving through real-time or periodic communication with the vehicle device 300. The driving data may include information such as a position of the vehicle being driven, road conditions (e.g. straight road, curved road) on which the vehicle is driving, road surface conditions (e.g. gravel road, cement road, dirt road), driving speed at the position of the vehicle, and steering angle. The controller 230 may analyze the driving data of the vehicle to identify the driver's driving tendency. More specifically, the controller 230 may estimate the driver's driving tendency by classifying it into indices such as city driving, high-speed driving, fuel-efficient driving, comfortable driving, off-road driving, and sporty driving through driving data analysis.

In Step 413, the controller 230 identifies a tuning map related to the driver's driving tendency estimated based on the driving data identified in Step 407 as a recommended tuning map among the plurality of tuning maps stored in the memory 220. The controller 230 may transmit a list of the identified recommended tuning maps to the user device 100. In Step 415, when a signal for selecting any one of the lists is received from the user device 100, the controller 230 returns to Step 315 of FIG. 3.

In Step 409, the controller 230 performs Step 411 when tags and driving data are selected as recommendation conditions for recommending the tuning map from the user device 100, and returns to Step 315 of FIG. 3 when the tags and driving data are not selected.

In Step 411, the controller 230 identifies the tags stored in the user device 100 and the driving data of the vehicle. The controller 230 may cross-analyze the tags and the vehicle's driving data to estimate the driver's driving tendency.

In Step 413, the controller 230 identifies a tuning map related to the driver's driving tendency estimated based on the tags and driving data identified in Step 411 as a recommended tuning map among the plurality of tuning maps stored in the memory 220. The controller 230 may transmit a list of the identified recommended tuning maps to the user device 100. In Step 415, when a signal for selecting any one of the lists is received from the user device 100, the controller 230 returns to Step 315 of FIG. 3, and when no selection signal is received, the controller 230 returns to Step 401.

In addition, in order to recommend the tuning map as in Step 413, the memory 220 may store a plurality of tuning maps. More specifically, the tuning map stored in the memory 220 may include various tuning maps uploaded and shared by other user devices, tuning maps generated by artificial intelligence algorithms, and the like. In addition, the tuning map stored in the memory 220 may include feedback information received from other user devices, tag information set in the tuning map, and driving tendency estimated based on driving data information for the tuning map.

FIG. 5 is a flowchart for illustrating a method of generating a tuning map according to an embodiment of the present disclosure.

Referring to FIG. 5, in Step 501, the controller 230 performs Step 503 according to the selection signal for the tuning component received from the user device 100, identifies the tunable range of the tuning component, and displays the tunable range on the user device 100. In Step 505, the controller 230 determines whether the range of the expert area is selected from the tunable range from according to the selection signal for the tuning value received from the user device 100 or not. When the range of the expert area is selected from the tunable range from the user device 100, the controller 230 performs Step 507, and when no range of the expert area is selected, the controller 230 performs Step 511. In Step 511, the controller 230 identifies the tuning value for the tuning component according to the selection signal for the tuning value received from the user device 100, and performs Step 513.

On the other hand, when a fee is paid from the user device 100 in Step 507 to set the tuning value included in the expert area, in Step 509, the controller 230 recommends an expert related to the tuning component selected in Step 501 from among the at least one pre-registered expert to the user device 100. Through this, the user device 100 selects the tuning value in the expert area through communication with the expert, and the controller 230 receives the tuning value, and performs Step 513.

In Step 513, the controller 230 generates the tuning map based on the tuning component and the tuning value selected from the user device 100. In Step 515, when the tag for the tuning map generated from the user device 100 is received, the controller 230 may add the received tag to the tuning map.

In Step 517, the controller 230 determines whether a tuning map generation completion signal is received from the user device 100 or not. When a tuning map generation completion signal is received from the user device 100, the controller 230 performs Step 519, and when no tuning map generation completion signal is received, the controller 230 returns to Step 501 and re-perform Steps 501 to 515. In addition, when the user device 100 pays a fee to the expert to generate the tuning map in order to tune one tuning component, the controller 230 may omit the fee payment step when selecting a tuning value for another tuning component.

In Step 519, the controller 230 may store the tuning map to which the tag is added in the memory 220. Through this, the user device 100 and other user devices may access the application, identify the tuning map, and apply feedback to the tuning map.

The embodiments of the present disclosure and drawings are presented only by specific examples for ease of describing the technical contents of the present disclosure and to assist in understanding the present disclosure, and are not intended to limit the scope of the present disclosure. Therefore, it should be interpreted that all modifications or modified forms derived based on the technical spirit of the present disclosure are included in the scope of the present disclosure.

What is claimed is:

1. A method for setting a driving mode of a vehicle, the method comprising:
performing, by an electronic device, login using a user information received from a user device;
setting, by the electronic device, a tuning map for setting the driving mode of the vehicle based on a signal received from the user device; and
remotely setting, by the electronic device, the driving mode of the vehicle based on the tuning map.

2. The method of claim 1, wherein the setting of the tuning map comprises:
receiving a selection signal for a tuning component and a tuning range for generating the tuning map from the user device; and
setting the tuning map based on the selection signal received from the user device.

3. The method of claim 2, further comprising:
when the tuning range received from the user device exceeds a threshold range, setting, by the electronic device, the tuning map based on a tuning range received from at least one expert device.

4. The method of claim 3, further comprising:
getting, by the electronic device, authorization from the at least one expert device to set the tuning map based on the tuning range received from the at least one expert device.

5. The method of claim 3, further comprising:
receiving, by the electronic device, at least one tag associated with the set tuning map from the user device and adding, by the electronic device, the tag to the tuning map.

6. The method of claim 5, wherein the setting of the tuning map comprises:
identifying a recommendation condition of the tuning map received from the user device; and
identifying a tuning map corresponding to the recommendation condition in at least one tuning map received from one or more of other user devices and at least one tuning map learned using an artificial intelligence algorithm.

7. The method of claim 6, wherein the identifying of the recommendation condition of the tuning map comprises:
identifying at least one tag stored in the user device as the recommendation condition of the tuning map.

8. The method of claim 6, wherein the identifying of the recommendation condition of the tuning map comprises:
identifying a driving data for driving the vehicle associated with the user device as the recommended condition of the tuning map.

9. The method of claim 6, wherein the identifying of the recommendation condition of the tuning map comprises:
identifying at least one tag stored in the user device and a driving data for driving the vehicle as the recommended condition of the tuning map.

10. The method of claim 6, wherein the at least one tuning map received from the one or more of other user devices comprises a feedback information on the tuning map, a tag information set in the tuning map, and a driving data information on the tuning map.

11. An apparatus for setting a driving mode of a vehicle, comprising:
a communicator configured to communicate with a user device and a vehicle device configured to set the driving mode of the vehicle; and
a controller configured to perform login using a user information received from the user device, generate a control signal for setting the driving mode of the vehicle according to a tuning map set based on a signal received from the user device, and control the communicator to transmit the control signal to a vehicle device.

12. The apparatus of claim 11, wherein the controller is configured to set the tuning map based on a selection signal for a tuning component and a tuning range for generating the tuning map, wherein the selection signal is received from the user device.

13. The apparatus of claim 12, wherein the controller is configured to, when the tuning range received from the user device exceeds a threshold range, set the tuning map based on a tuning range received from at least one expert device.

14. The apparatus of claim 13, wherein the controller is configured to get authorization from the at least one expert device to set the tuning map based on the tuning range received from the at least one expert device.

15. The apparatus of claim 13, wherein the controller is configured to receive at least one tag associated with the set tuning map from the user device and adding the tag to the tuning map.

16. The apparatus of claim 15, wherein the controller is configured to identify a recommendation condition of the tuning map received from the user device, and identify a tuning map corresponding to the recommendation condition in at least one tuning map received from one or more of other user devices and at least one tuning map learned using an artificial intelligence algorithm.

17. The apparatus of claim 16, wherein the controller is configured to identify at least one tag stored in the user device as the recommendation condition of the tuning map.

18. The apparatus of claim 16, wherein the controller is configured to identify a driving data for driving the vehicle associated with the user device as the recommended condition of the tuning map.

19. The apparatus of claim 16, wherein the controller is configured to identify at least one tag stored in the user device and a driving data for driving the vehicle as the recommended condition of the tuning map.

20. The apparatus of claim 16, wherein the at least one tuning map received from the one or more of other user devices comprises a feedback information on the tuning map, a tag information set in the tuning map, and a driving data information on the tuning map.
